(19) United States
(12) Patent Application Publication
(10) Pub. No.: US 2015/0326774 A1
(43) Pub. Date: Nov. 12, 2015

(54) DEVICE WITH TWO WIRELESS PROTOCOLS

(71) Applicant: Robert Chinery III, Wall, NJ (US)

(72) Inventor: Robert Chinery III, Wall, NJ (US)

(73) Assignee: Comanche Outfitters LLC, Manasquan, NJ (US)

(21) Appl. No.: 14/705,500

(22) Filed: May 6, 2015

Related U.S. Application Data
(60) Provisional application No. 61/989,212, filed on May 6, 2014.

(51) Int. Cl. H04N 5/232; A01M 31/00; H04W 52/02; H04N 7/18; H04N 5/14

(52) U.S. Cl. CPC H04N 5/23203; H04N 7/185; H04N 5/144; H04W 52/0251; A01M 31/002; H04W 80/045

(57) ABSTRACT

A system composed of a mobile device and field camera is disclosed. The field camera includes an imaging module that electronically records still image data upon detection of motion, a first wireless module adapted to that receives data from the mobile device over the first wireless protocol, a second wireless module that transmits data to the mobile device over the second wireless protocol, the second wireless protocol being capable of transmitting data at a faster rate than the first wireless protocol, a battery capable of supplying DC power to the field camera, and a processor in communication with the imaging module, the first wireless module, the second wireless module, and the battery. Upon receipt of data from the mobile device over the first wireless protocol, the processor initializes the second wireless module so the second wireless processor may transmit still image data to the mobile device.

### CROSS-REFERENCE TO RELATED APPLICATIONS

The present application claims the benefit of U.S. Provisional Patent Application Ser. No. 61/989,212 filed May 6, 2014, the disclosure of which is hereby incorporated by reference herein.

### BACKGROUND OF THE INVENTION

The present invention relates generally to devices which are provided with wireless protocols. In one application, the device is a motion sensing photographic and video camera that automatically records data for subsequent retrieval.

Such cameras find a great deal of conventional use in the sporting industry, where field cameras are used to discretely capture photographs and video of wild game. Data retrieved from such cameras can then be utilized by gamesman as they see fit, such as to identify animal species in an area, evaluate the general health of a population in that area, or to identify volume and appearance times of game that are desirable for hunting. Cameras of this type also find use as security or surveillance cameras where criminal or otherwise objectionable activity can be documented and monitored.

Conventional motion sensing cameras rely on non-volatile memory cards such as secure digital (“SD”), Compact Flash (“CF”), or Memory Stick (“MS”) cards, to store captured data. To view the stored data, a user must physically retrieve either the camera or the memory card and upload the stored data to a personal computer by tethering to the camera device itself or by removing the memory card and inserting it into a computer readable device. Other cameras of this type bypass the physical retrieval step and are able to transfer data to mobile devices through cellular data plans. Still other cameras utilize a wireless protocol such as Wi-Fi to download data to a mobile device.

Physical retrieval or retrieval through Wi-Fi is a nuisance as it is often desirous to place motion sensing cameras in remote locations, such as in hunting blinds, deer stands, or high up on exterior building walls, and physical access is required for these options. While data transfer through cellular data plans can be favorable in such a situation, the expenses associated with cellular enabled cameras and appurtenant data plans are prohibitive for many prospective users.

### SUMMARY OF THE INVENTION

It would therefore be beneficial to provide a device such as a motion sensing camera that is capable of transferring stored data wirelessly by means other than cellular, while preserving battery life. The inventive motion sensing camera achieves just this result by featuring dual integrated wireless capability, including an “always on” low power wireless protocol useful for “initiating” a higher power wireless protocol, where both protocols communicate with a single mobile device. In this manner, battery life of the motion sensing camera is preserved while still permitting a user to, when wanted, access all of the photographs and videos stored in the motion sensing camera directly from the user's mobile device using a high power high speed wireless protocol. In preferred embodiments, the low power wireless protocol is Bluetooth LE and the high power wireless protocol is Wi-Fi under the IEEE 802.11 standard.

In one embodiment of the invention, a method of extending the run time of a component when used in conjunction with a mobile device capable of transmitting data over a first wireless protocol and both receiving and transmitting data over a second wireless protocol is provided. In this embodiment, the component comprises a first wireless module adapted to receive data from the mobile device over a first wireless protocol and a second wireless module adapted to transmit and receive data to and from the mobile device over a second wireless protocol where the first wireless protocol is a lower power protocol than the second wireless protocol. Upon receipt of wireless data from the mobile device over the first wireless protocol, the component energizes the second wireless module for transmission of data to and from the mobile device over the second wireless protocol.

The first wireless protocol may be a Bluetooth LE protocol. The second wireless protocol may be a Wi-Fi protocol. The Wi-Fi protocol may be an IEEE 802.11 protocol.

The component may be a motion sensing photographic and video camera. The mobile device may be one of a mobile phone or a tablet.

In another embodiment of the invention, a still photograph and video imaging device includes an imaging system adapted to electronically record photographs and motion video, a first wireless module adapted to receive data from a mobile device over a first wireless protocol, a second wireless module adapted to both receive data from the mobile device and transmit data to the mobile device over a second wireless protocol, the second wireless protocol being a higher power wireless protocol than the first wireless protocol, and a processor in communication with the imaging system, the first wireless module, and the second wireless module. Upon receipt of data from the mobile device by the first wireless module, the processor automatically initializes the second wireless module to transmit data to the mobile device.

The imaging system may further comprise a motion sensor adapted to initiate recording of the photographs and motion video.

The first wireless protocol may be a Bluetooth LE wireless protocol. The second wireless protocol may be a Wi-Fi protocol. The Wi-Fi protocol may be an IEEE 802.11 protocol.

In a further embodiment of the invention, a photograph and video system comprises a mobile device having first and second wireless protocols, a field camera comprising an imaging module adapted to electronically record still image data upon detection of motion, a first wireless module adapted to receive data from the mobile device over the first wireless protocol, a second wireless module adapted to transmit data to the mobile device over the second wireless protocol, the second wireless protocol being capable of transmitting data at a faster rate than the first wireless protocol, and a processor in communication with the imaging module, the first wireless module, and the second wireless module. Upon receipt of data from the mobile device over the first wireless protocol, the processor initiates the second wireless module so the second wireless module may transmit still image data to the mobile device.

The imaging module may be adapted to electronically record motion video data upon detection of motion and the second wireless module may be adapted to transmit the motion video data to the mobile device.

The first wireless protocol may be Bluetooth LE and the second wireless protocol may be Wi-Fi.

Following transmission of data from the second wireless module to the mobile device, the processor may automatically shut down the second wireless module after a predetermined time interval. The predetermined time interval may be less than 5 minutes.

### BRIEF DESCRIPTION OF THE DRAWINGS

FIG. 1 depicts a schematic view of a device used with a mobile device in accordance with the present invention;

FIG. 2 depicts an algorithm describing one manner of use of the device of FIG. 1.

### DETAILED DESCRIPTION

In describing the embodiments illustrated in the drawings, specific terminology will be used for the sake of clarity. However, the invention is not intended to be limited to the specific terms so selected, and it is to be understood that each specific term includes all technical equivalents that operate in a similar manner to accomplish a similar purpose.

Devices provided in accordance with the present invention feature dual integrated wireless capability enabling the transfer of stored data wirelessly by means other than cellular, while preserving battery life. Included in the dual integrated wireless capabilities are an “always on” low power wireless protocol useful for “initiating” a higher power wireless protocol, where both protocols communicate with a single mobile device. In this manner, battery life of the motion sensing camera is preserved while still permitting a user to access all of the photographs and videos stored in the motion sensing camera directly from the user's mobile device using a high power high speed wireless protocol.

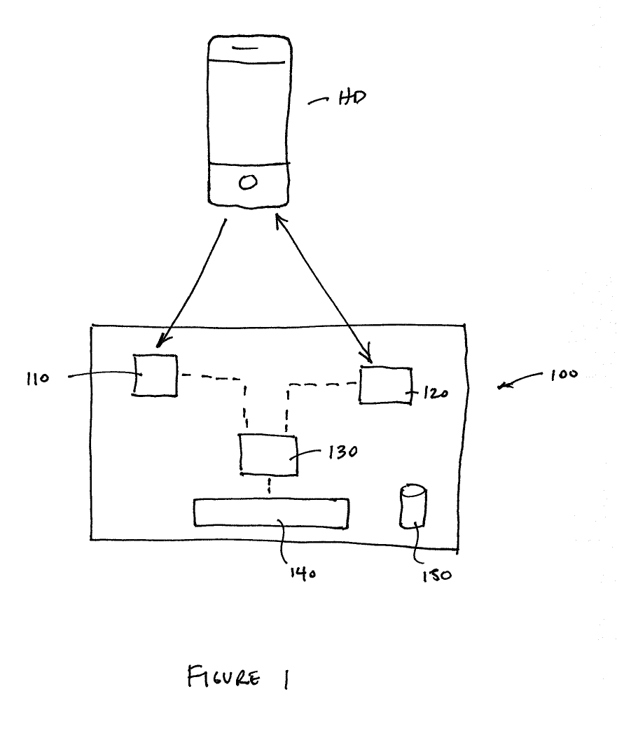

An exemplary embodiment of a motion sensing camera with dual wireless functionality is shown in FIG. 1.

As shown, the device 100 includes a first wireless module 110 and a second wireless module 120. The two modules 110, 120 are in communication with a processor 130. In turn, the processor communicates with other components of the device 140, such as still or video motion cameras, flash modules, motion sensors, and virtually endless other components. In this regard, it is also to be understood that the device of FIG. 1 is inclusive of standard components necessary to make the device useable, such as provisions for providing power, for example a battery 150.

In the device shown in FIG. 1, the first wireless module 110 is in an “always on” condition. That is, when power is flowing through the device as directed by a user, typically through an on/off switch or other known means (not shown), the first wireless module is constantly seeking a client to pair with. By constant, it is to be understood that the first wireless module 110 may operate on a time repeating basis, for example seeking a pairing every 60 seconds, 30 seconds, 15 seconds, 10 seconds, 1 second, or the like. It is preferred that the first wireless module 110 receive data over a low energy consumption wireless protocol. Examples of modules capable of achieving these results are Bluetooth LE modules, also referred to as a Bluetooth Smart module, as implemented in Bluetooth 4.0. Of course, other known and future low energy consumption wireless protocols and associated hardware may also be utilized.

Once the first wireless module receives a “wake up” signal, typically from a user's mobile device MD, the module sends a signal to the processor 130 which is programmed to then fully power up the second wireless module 120, which otherwise sits idle. The second wireless module 120 may then communicate with the same mobile device MD to transfer data bilaterally, at a much greater data rate than would otherwise be achievable through the first wireless module 110. Notably, this also requires much greater power consumption. It is preferred that the second wireless module be provided as a Wi-Fi module, such as those that operate under the IEEE 802.11 standard.

It will be appreciated that in order for the mobile device MD to communicate with the camera 100, and specifically the first and second wireless modules 110, 120, the mobile device can download and install an appropriate program designed to run specifically on a mobile platform, such as a mobile app. This mobile app is used for all communication between the mobile device MD and camera 100, including the communications to change camera settings.

As shown in FIG. 1, it is preferred that the first and second client be a single client in the form of a mobile device. The mobile devices may be mobile phones, tablets, or the like, and may be referred to as handheld devices. In the preferred embodiment, the mobile device would be required to include both Bluetooth LE and Wi-Fi modules.

The present market includes an ever increasing array of such devices, such as the iPhone 4s and newer, iPad 3rd generation and newer, iPod Touch latest generation, Samsung Galaxy Series, Motorola Droid RAZR, Ultra, Maxx, Mini, Moto X, and Moto G, HTC One and One Max, LG G Series, Optimus Exceed 2, Fuel, L35, L80, L65, L70, L90, L40, G, G Pro, F70, Volt, VU 3.0, Google Nexus 4 and 5, and Sony Xperia Series devices. Other future devices are expected to also include these features.

The Wi-Fi transmitter of the present invention is reliably capable of transmitting data a maximum of approximately 150-200 feet depending on the terrain, particular mobile device being connected to, camera placement, etc. Under ideal conditions, the distance may be greater. At extended distances, it will be appreciated that while some transmission may be achieved, the rate may be slowed significantly.

In most preferred embodiments of the invention, the device is a motion sensing photographic and video camera. These devices generally consist of a wireless battery powered digital camera unit with infrared night vision capabilities. The camera is activated upon sensing motion using a motion sensor. Captured photographs and videos are stored to non-volatile memory cards, which may be accessed remotely using an integrated Wi-Fi module. In order to conserve power, the Wi-Fi module is connected through a processor to a Bluetooth LE module, such as a Bluetooth 4.0 module, or the like, which will remain active at all times while the camera is powered on, and will be used to selectively activate the more powerful Wi-Fi module upon command. Therefore, a command from the user's mobile device causes the Bluetooth LE unit to activate the Wi-Fi module, whereupon the same mobile device may communicate with the Wi-Fi module to access and download the contents of the camera's memory card. Additionally, the mobile device may adjust camera and other settings via its connection with the Bluetooth LE or Wi-Fi modules. Setting adjustments may consist of exposure compensation, resolution, video frame rate, ISO, and other conventional motion sensing or non-motion sensing camera settings.

Upon completion of a download procedure, the camera preferably automatically reverts solely to the low power mode, turning off the Wi-Fi module and reverting back to operation under Bluetooth LE. Typically this can be achieved by command or upon a period of inactivity, such as 5 minutes or less. In this low power mode, the motion sensor is preferably also active and the camera will use its technology to record activity occurring within view of the camera

The following represent examples of Wi-Fi characteristics under normal conditions of 25° C. and VDD-3.3V as well as typical Bluetooth module parameters.

### Example 1

RF Characteristics for IEEE802.11b

| Item | Contents |
|---|---|
| Specification | IEEE802.11b |
| Mode | DSSS/CCK 11 Mbps |
| Channel Frequency | 2412~2484 MHz |
| RX (per) | −85 dBm |
| TX Characteristics | |
| Power Level (+/−1.5 | 16 dBm |
| dBm) | |
| EVM (≦−15) | ≦−15 dB |

### Example 2

RF Characteristics for IEEE802.11g

| Item | Contents |
|---|---|
| Specification | IEEE802.11g |
| Mode | OFDM 54 Mbps |
| Channel Frequency | 2412~2484 MHz |
| RX (per) | −70 dBm |
| TX Characteristics | |
| Power Level (+/−1.5 | 14 dBm |
| dBm) | |
| EVM (≦−15) | ≦−28 dB |

### Example 3

RF Characteristics for IEEE802.11n

| Item | Contents |
|---|---|
| Specification | IEEE802.11n |
| Mode | OFDM 135 Mbps |
| Channel Frequency | 2412~2484 MHz |
| RX (per) | −70 dBm |
| TX Characteristics | |
| Power Level (+/−1.5 | 13 dBm |
| dBm) | |
| EVM (≦−15) | ≦−28 dB |

Typical Bluetooth Module Parameters

| Item | Contents |
|---|---|
| Standard | Bluetooth V4.0 LE |
| Transmission Power | Class 2 Max sending power 0 dBm |
| Sensitivity | −70 dBm < +/−0.1% BER |
| Operating Frequency | 2.402 GHz-2.480 GHz ISM |
| Receiving Sensitivity | 94 dBm @ 1 Mbps |

Cameras of the present invention typically have specifications consistent with the following:

| | |
|---|---|
| Image Sensor | 5 MP Color CMOS |
| Day/Night Mode | Yes |
| IR Range | 65 feet |
| IR Setting | Top: 19 LEDs on/off |
| | Bottom: 21 LEDs on/off |
| Memory | SD Card (8 MB-32 GB) |
| Cycle Recording | Selectable, deletes oldest data |
| | when on and memory card full |
| Operating Keys | 10 |
| Lens | F/3.0; FOV 52°; Auto IR-Cut- |
| | Remove (at night) |
| Digital Zoom | 2x, 3x, 4x, selectable |
| LCD Screen | 2″ TFT, RGB, 262k, 50 Hz |
| PIR Sensitivity | High/Normal/Low |
| PIR Distance | 39-65 ft |
| PIR Angle | 65° |
| Picture Size | 5 MP, 2592 × 1944 |
| | 8 MP, 3264 × 2448 |
| | 12 MP, 4000 × 3000 |
| Picture Format | JPEG |
| Video Resolution | 720P (1280 × 720), 640 × 320, |
| | 320 × 160 |
| Video Format | AVI |
| Video Length | 1-60 sec., programmable |
| Video Frame | 30/15 fps, programmable |
| Audio Recording | Yes |
| Multi-Shot | 1-7 photos per trigger, |
| | adjustable |
| Trigger Time | 0.8 seconds |
| Trigger interval | 2-5 seconds |
| Delay Interval Between Shots | Yes, configurable 5 seconds to |
| | 2 hours |
| Camera + Video | Yes, simultaneous video and |
| | photo |
| Stamp | Yes, selectable imprinting of |
| | programmed user label, moon |
| | phase, temperature, date, time |
| | of photo |
| Playback Zoom in | 2x, 3x, 4x |
| Device Serial No. | Yes |
| Time Lapse | Yes, 5 seconds to 24 hours |
| | during which time the PIR |
| | sensor is turned off |
| Beep Sound | On/off |
| SD Card Cycle | On/Off |
| Operation Power | Battery 6 V, DC 12 V |
| Battery Type | 8AA (optional 4AA) |
| External DC | 12 V |
| Stand-by Current | 0.15 mA |
| Stand-by Time | 4~6 months (4xAA~8xAA) |
| Timer | Selectable start/end times; |
| | camera only active between |
| | selected start and end times |
| Auto Power Off | After 60 seconds inactivity |
| Power Consumption | 150 mA (+650 mA when all 40 IR |
| | LEDs are active) |
| Low Battery Alert | 4.8 V |
| Low Battery Power Off | 4.6 V |
| Interface | TV out (NTSC/PAL)/USB/SD |
| | Card/DC Port |
| Mounting | Strap; Tripod |
| Operating Temperature | −25° F. to 140° F. |
| Storage Temperature | −30° F. to 158° F. |
| Operation Humidity | 5%-90% |
| Waterproof Specifications | IP54 |
| Interface Language | English, German, French, etc. |
| Dimensions | 131.42 × 98.72 × 77.44 mm |
| Weight | 300 g |
| Certification | CD RoHs |

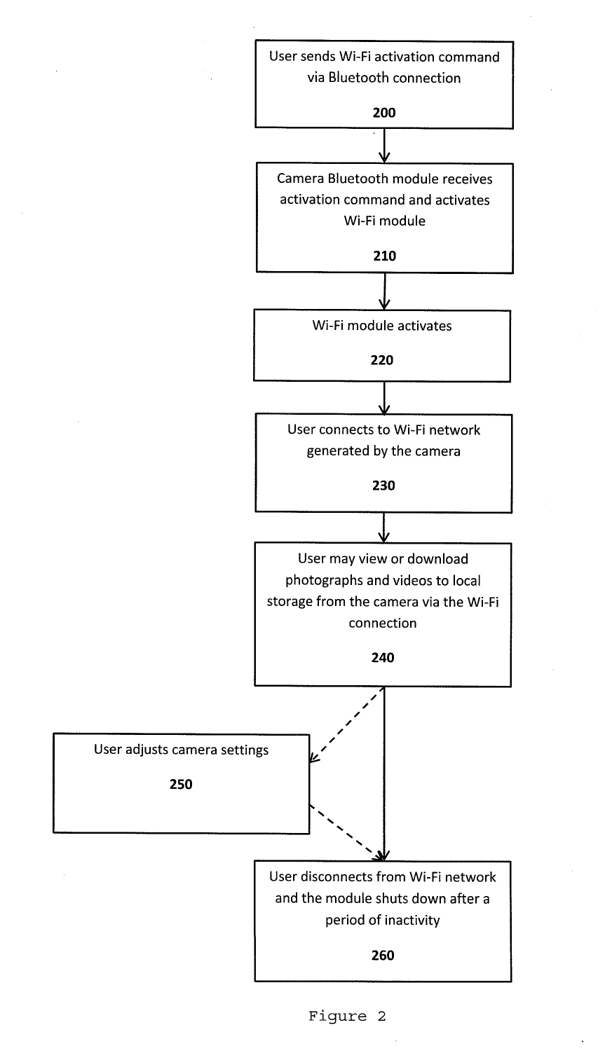

As shown in FIG. 2, in one manner of use a user may send a Wi-Fi activation command to the camera via a Bluetooth connection of his or her mobile device in step 200. This Wi-Fi activation command can be a relatively small packet of information containing only the initiation instructions. In other embodiments it may be slightly more robust.

As previously discussed, the user must first download and install an appropriate mobile app onto his or her mobile device. As with conventional mobile apps, this process only needs to be conducted once as the app resides on the mobile device thereafter.

In a next step 210, the camera receives the Bluetooth command and activates a Wi-Fi module, whereupon the Wi-Fi module activates in step 220. The user may then connect to the Wi-Fi module via a Wi-Fi module in his or her mobile device in step 230.

In a subsequent step 240, the user may view or download photographs and videos from the camera via the Wi-Fi connection. Thus the photographs and videos can be stored in the mobile device or moved to other storage solutions, such as cloud storage, through the mobile device. Moreover, the user may transfer the photos and videos to others through e-mail, instant messaging, social media postings, or the like. Once in the mobile device, the movement and transfer of photographic and video data is dictated by the capabilities of the mobile device.

Either prior to step 240, or following step 240 as shown in FIG. 2, the user may adjust camera settings of the camera in step 250. The camera settings that may be adjusted include exposure compensation, resolution, video frame rate, ISO, and other conventional motion sensing or non-motion sensing camera settings.

Finally, in step 260, either the user disables the Wi-Fi module manually or the module shuts down following a period of inactivity. In this case, the Bluetooth module will continue to be energized and will continue to seek a host to connect with.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

1. A method of extending the run time of a component when used in conjunction with a mobile device capable of transmitting data over a first wireless protocol and both receiving and transmitting data over a second wireless protocol, the component comprising:
a first wireless module adapted to receive data from the mobile device over a first wireless protocol;
a second wireless module adapted to transmit and receive data to and from the mobile device over a second wireless protocol;
wherein said first wireless protocol is a lower power protocol than said second wireless protocol; and,
wherein upon receipt of wireless data from the mobile device over said first wireless protocol, the component energizes said second wireless module for transmission of data to and from the mobile device over said second wireless protocol.

2. The method of claim 1, wherein said first wireless protocol is a Bluetooth LE protocol.

3. The method of claim 2, wherein said second wireless protocol is a Wi-Fi protocol.

4. The method of claim 3, wherein said Wi-Fi protocol is an IEEE 802.11 protocol.

5. The method of claim 1, wherein the component is a motion sensing photographic and video camera.

6. The method of claim 5, wherein the mobile device is one of a mobile phone or a tablet.

7. A still photograph and video imaging device comprising:
an imaging system adapted to electronically record photographs and motion video;
a first wireless module adapted to receive data from a mobile device over a first wireless protocol;
a second wireless module adapted to both receive data from the mobile device and transmit data to the mobile device over a second wireless protocol, said second wireless protocol being a higher power wireless protocol than said first wireless protocol; and,
a processor in communication with said imaging system, said first wireless module, and said second wireless module;
wherein upon receipt of data from the mobile device by said first wireless module, said processor automatically initializes said second wireless module to transmit data to the mobile device.

8. The device of claim 7, wherein said imaging system further comprises a motion sensor adapted to initiate recording of said photographs and motion video.

9. The device of claim 7, wherein said first wireless protocol is a Bluetooth LE wireless protocol.

10. The device of claim 9, wherein said second wireless protocol is a Wi-Fi protocol.

11. The device of claim 10, wherein said Wi-Fi protocol is an IEEE 802.11 protocol.

12. A photograph and video system comprising:
a mobile device having first and second wireless protocols;
a field camera comprising
an imaging module adapted to electronically record still image data upon detection of motion;
a first wireless module adapted to receive data from said mobile device over said first wireless protocol;
a second wireless module adapted to transmit data to said mobile device over said second wireless protocol, said second wireless protocol being capable of transmitting data at a faster rate than said first wireless protocol; and,
a processor in communication with said imaging module, said first wireless module, and said second wireless module;
wherein upon receipt of data from said mobile device over said first wireless protocol, said processor initiates said second wireless module so said second wireless module may transmit still image data to said mobile device.

13. The system of claim 12, wherein said imaging module is adapted to electronically record motion video data upon detection of motion and said second wireless module is adapted to transmit said motion video data to said mobile device.

14. The field camera of claim 12, wherein said first wireless protocol is Bluetooth LE and said second wireless protocol is Wi-Fi.

15. The field camera of claim 12, wherein following transmission of data from said second wireless module to said mobile device, said processor automatically shut down said second wireless module after a predetermined time interval.

16. The field camera of claim 15, wherein said predetermined time interval is less than 5 minutes.
